(19) United States
(12) Patent Application Publication
(10) Pub. No.: US 2015/0172806 A1
(43) Pub. Date: Jun. 18, 2015

(54) CUSTOM EAR MONITOR

(71) Applicant: UNITED SCIENCES, LLC, ATLANTA, GA (US)

(72) Inventors: WESS ERIC SHARPE, VININGS, GA (US); KAROL HATZILIAS, ATLANTA, GA (US)

(21) Appl. No.: 14/109,799

(22) Filed: Dec. 17, 2013

(51) Int. Cl. H04R 1/10

(52) U.S. Cl. CPC H04R 1/1083; H04R 1/1075

(57) ABSTRACT

A custom ear monitor, the custom earbud including an earpiece body manufactured from an image created from a three dimensional (‘3D’) optical scan of a user's ear; and one or more speakers located within the earpiece.

### BACKGROUND

Ear monitors are devices used by musicians, audio engineers and audiophiles to listen to music or to hear a custom crafted mix of vocals and stage instrumentation for live performance or recording studio mixing. They are often custom fitted for an individual's ears to provide comfort and a high level of noise reduction from ambient surrounding

### SUMMARY

A custom ear monitor, the custom earbud including an earpiece body manufactured from an image created from a three dimensional (‘3D’) optical scan of a user's ear; and one or more speakers located within the earpiece.

### BRIEF DESCRIPTION OF THE DRAWINGS

FIG. 1 sets forth a line drawing of a custom ear monitor according to embodiments of the present invention.

### DETAILED DESCRIPTION OF EXAMPLE EMBODIMENTS

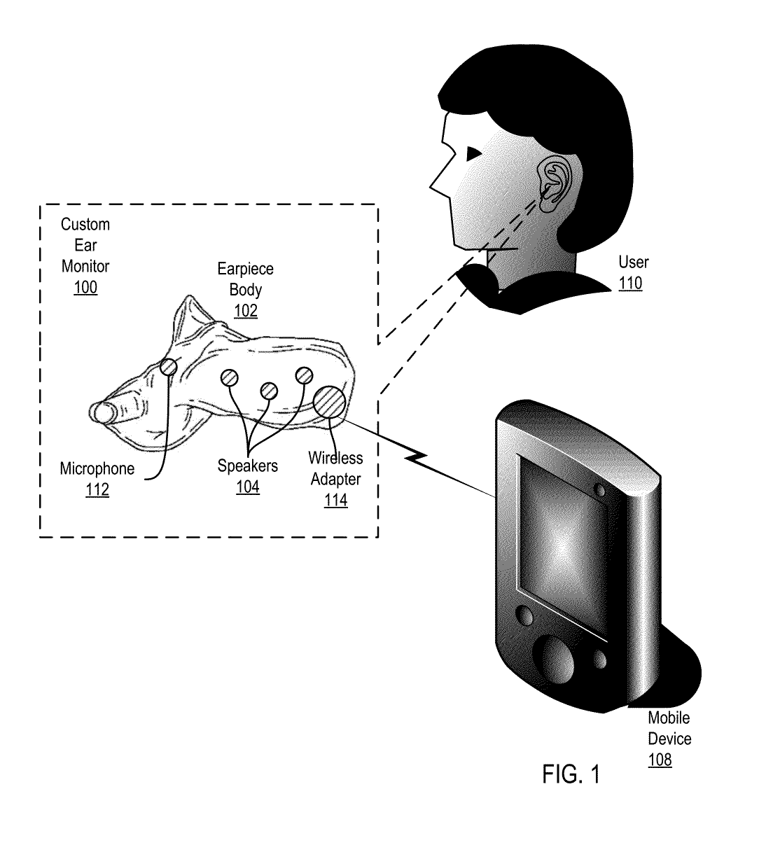

Example methods, wearable computers, apparatuses, and products for custom ear monitors in accordance with the present invention are described with reference to the accompanying drawing. FIG. 1 sets forth a line drawing of a custom ear monitor according to embodiments of the present invention. The custom ear monitor (100) of Figure includes an earpiece body (102) manufactured from an image created from a three dimensional (‘3D’) optical scan of a user's ear. Typically, such an image includes a three dimensional image (‘3D’) of the interior of the user's ear such as the ear canal. In some embodiments, portions of the exterior of the user's ear are also imaged. Such an image may be created from a three dimensional (‘3D’) optical scan of a user's ear (110). Creating a 3D image derived from a 3D optical scan of the interior of the patient's ear canal can be carried out using methods and systems described in U.S. patent application Ser. Nos. 13/417,649; 13/417,767, 13/586,471; 13/586,411; 13/586,459; 13/546,448; 13/586,448; 13/586,474; 14/040,973, 14/041,943; 14/049,666; 14/049,530; 14/049,687, all incorporated by reference herein in their entirety.

The example custom ear monitor (102) of FIG. 1 also includes one or more speakers (104) located within the earpiece body (102). In the example of FIG. 1 the 3D optical scan of the user's ear identifies the location of the tympanic membrane of the user and the one or more speaker (104) are oriented in dependence upon the location of the tympanic membrane. Orienting speakers in dependence of such location or orientation provides improved quality and efficiency in audio presentation.

The example custom ear monitor (102) of FIG. 1 a wireless adapter (114) is configured for data communications with a mobile device. The wireless adapter may be implemented as a Bluetooth adapter or any other wireless adapter that will occur to those of skill in the art. Bluetooth is a wireless technology standard for exchanging data over short distances (using short-wavelength microwave transmissions in the ISM band from 2400-2480 MHz) from fixed and mobile devices.

The example custom ear monitor (102) of FIG. 1 includes a microphone (112) configured to sense noise outside the ear monitor (100). In the example of FIG. 1, the microphone (112) is configured to sense noise outside the ear monitor and transmit the noise to the speakers within the ear monitor. This microphone configuration allows situational awareness for the user. In some cases whether external sound from the microphone should be transmitted through the speakers to the user is dependent upon a profile, a threshold, or other information to determine whether external sound should be transmitted to the user.

In various embodiments, the ear monitor (102) may be configured to amplify sound received at the microphone (112) and play the amplified sound through the speakers (104). In such embodiments, the ear monitor (102) may provide enhanced hearing capabilities for hearing impaired users, or other users who may desire to better hear external sounds. In other embodiments, the ear monitor (102) may be configured to transmit only sounds of a particular frequency or from a particular frequency range from the microphone (112) to the speakers (104). For example, the ear monitor (102) may be configured to transmit only frequencies in the voice frequency (e.g., about 300 Hz to about 3400 Hz) from the microphone (112) to the speakers (104). This may, for example, enable a user to better hear others speaking without having other, less desired sounds amplified as well.

In various embodiments, the custom ear monitor (100) is configured to receive (e.g., via the wireless adapter (114)) one or more audio signals that the monitor (100) is configured to play through the speakers (104). The one or more audio signals may include, for example, one or more audio signals from the mobile device (108) such as, for example, audio from radio or music files, movies, or any other suitable audio source. In other embodiments, the one or more audio signals may include one or more live feedback audio signals such as from a musical instrument or microphone (e.g., a musical instrument that the user is currently playing or a microphone that the user is currently singing through).

In particular embodiments, the speakers (104) may include any suitable combination of speakers. For example the speakers (104) may include one or more mid-range speakers (which may, for example, reproduce sound in a frequency range from about 300 Hz to about 5000 Hz), one or more high-range speakers (which may, for example, reproduce sound in a frequency range from about 2000 Hz to about 20000 Hz), one or more low-range speakers (which may, for example, reproduce sound in a frequency range from about 20 Hz to about 1 kHz), or any other suitable speaker or combination of speakers.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A custom ear monitor, the custom ear monitor comprising:
an earpiece body manufactured from an image created from a three dimensional (‘3D’) optical scan of a user's ear; and
one or more speakers located within the earpiece.

2. The custom ear monitor of claim 1 wherein the 3D optical scan of the user's ear identifies the location of the tympanic membrane of the user and the one or more speaker are oriented in dependence upon the location of the tympanic membrane.

3. The custom ear monitor of claim 1 further comprising a wireless adapter configured for data communications with a mobile device.

4. The custom ear monitor of claim 1 further comprising a microphone configured to sense noise outside the ear monitor.

5. The custom ear monitor of claim 4 wherein the microphone is configured to sense noise outside the ear monitor and transmit the noise to the speakers within the ear monitor.

6. The custom ear monitor of claim 5 wherein the microphone is configured to sense noise over a particular frequency range outside the ear monitor and transmit the noise in that particular frequency range to the speakers within the ear monitor.

7. The custom ear monitor of claim 6 wherein the particular frequency range is between about 300 Hz and about 3400 Hz.
